(19) United States
(12) Patent Application Publication
(10) Pub. No.: US 2005/0168334 A1
(43) Pub. Date: Aug. 4, 2005

(54) Method and system for monitoring environmental events

(76) Inventors: Clint W. Junell, Amarillo, TX (US); Mark D. Lindsey, Amarillo, TX (US)

Correspondence Address: JACKSON WALKER LLP, 2435 NORTH CENTRAL EXPRESSWAY, SUITE 600, RICHARDSON, TX, 75080, US

(21) Appl. No.: 10/767,489

(22) Filed: Jan. 29, 2004

(51) Int. Cl. G08B 29/00

(52) U.S. Cl. 340/506

(57) ABSTRACT

The present invention includes a method of responding to an environmental event. One or more event detectors within an environment are monitored and an alarm is triggered when the event detectors indicate an environmental event has occurred. A monitoring service is automatically notified that the environmental event has occurred and the existence of the environmental event is then verified. Service is requested from a pre-approved vendor qualified to address and/or correct the environmental event. Correction and/or addressing of the environmental event are then verified.

### TECHNICAL FIELD OF THE INVENTION

This invention generally relates to a method and system to monitor environmental events and, in particular, relates to a monitoring system that detects an adverse condition within a structure and dispatches a service to correct the condition before damages escalate.

### BACKGROUND OF THE INVENTION

Without limiting the scope of the invention, its background is described in connection with building utility systems and is best exemplified by methods and processes for detecting and repairing utility malfunctions such as water or gas leaks, for example.

Consumers spend millions of dollars each year to secure their investments in residences and businesses. Many consumers install security systems and hire monitoring services to prevent losses resulting from burglary or fire. When a burglar or fire alarm on the security system is triggered, the monitoring service may alert and summon police or firemen to the alarm address.

Fire and burglary are often catastrophic events that result in total or substantial loss. After such an event begins, the loss is usually significant unless the emergency service's response time is extremely short. Significant losses also occur, however, as a result of less monitored environmental conditions such as water damage caused by plumbing leaks or even explosions caused by gas leaks.

Although leaks and similar conditions may initially be relatively benign, these environmental conditions can also be catastrophic. In fact, if detected early, these conditions may be contained and repaired before significant and extensive damage occurs. Unlike burglary or fire, however, dedicated civil servants are not available for dispatch to a water leak. In fact, although systems to monitor water and gas leaks exist, most buildings are not equipped to monitor these or other detrimental environmental conditions.

Therefore, what is needed is a method and system for monitoring potentially damaging environmental conditions that does not rely solely on civil servants to respond to the condition. Additionally, a system for environmental monitoring is needed that does not allow a condition to escalate and cause additional damage.

### SUMMARY OF THE INVENTION

The present invention includes a method of responding to an environmental event. One or more event detectors within an environment are monitored and an alarm is triggered when the event detectors indicate an environmental event has occurred. A monitoring service is automatically notified that the environmental event has occurred and the existence of the environmental event is then verified. Service is requested from a pre-approved vendor qualified to correct and/or address the environmental event. Correction and/or addressing of the environmental event are then verified.

In another embodiment of the invention, a system for responding to an environmental event has an event detector to detect the environmental event. A monitoring system is connected to the event detector and is configured to generate an alarm when the environmental event is detected. A dispatch system receives the alarm from the monitoring system. A database containing pre-approved vendors qualified to address the environmental event is accessible by the dispatch system.

In another embodiment of the invention, a method of responding to an environmental event has the steps of receiving a notification of the environmental event from an authorized source. The environmental event is then identified and a pre-approved vendor, which is qualified to address the environmental event, is selected. Service is then requested from the pre-approved vendor. Correction and/or addressing of the environmental event by the pre-approved vendor are verified.

### BRIEF DESCRIPTION OF THE FIGURES

For a more complete understanding of the present invention, including its features and advantages, reference is now made to the detailed description of the invention taken in conjunction with the accompanying drawings in which like numerals identify like parts and in which:

FIG. 1 is a schematic diagram of an environmental monitoring system according to one embodiment of the present invention;

FIGS. 2A and 2B are flow charts of an environmental monitoring system according to one embodiment of the present invention; and

FIGS. 3A, 3B, 3C and 3D are flow charts of an environmental monitoring system according to one embodiment of the present invention.

### DETAILED DESCRIPTION OF THE INVENTION

While the making and using of various embodiments of the present invention are discussed in detail below, it should be appreciated that the present invention provides many applicable inventive concepts that may be embodied in a wide variety of specific contexts. The specific embodiments discussed herein are merely illustrative of specific ways to make and use the invention and do not limit the scope of the invention.

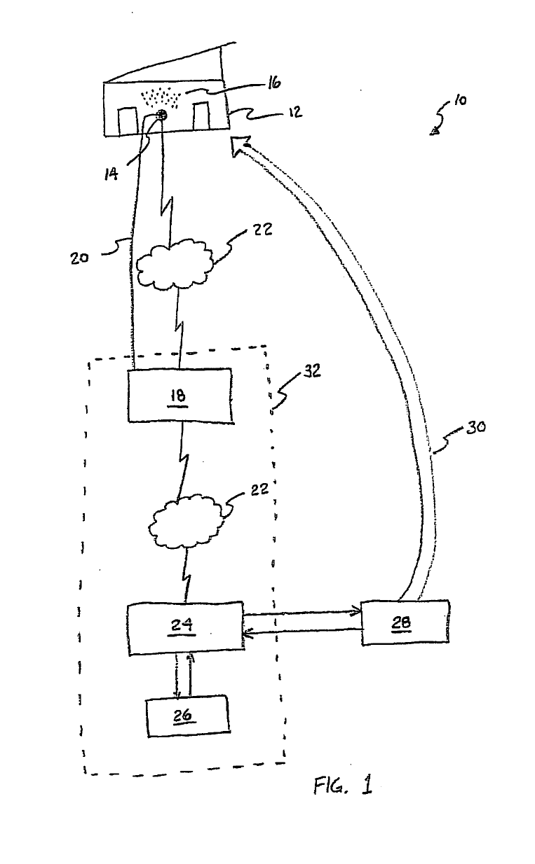

Referring to FIG. 1, an environmental monitoring system 10 according to one embodiment of the present invention serves to protect a client location 12 from damage caused by an environmental event. The client location 12 may be a house, business or associated premises and the like. One or more event detectors 14 are placed on or about the client location 12. These event detectors 14 may be configured to detect one or more event indicators 16 such as gases, water, radiation, or extreme temperatures, for example. The environmental monitoring system 10 may also be configured to monitor or identify multiple environmental events such as water leaks, natural gas leaks, carbon monoxide or radon accumulation and the like. Event detectors 14 may be commercially available sensors that detect a particular event indicator 16 and trigger an alarm signal, which is sent to a monitoring service 18.

The environmental monitoring system 10 may utilize an existing alarm monitoring service 18 that provides constant fire or burglary monitoring services. Alternatively, the monitoring service 18 may be performed by a computer within the environmental monitoring system 10. When the detector 14 detects an event indicator 16, the alarm signal may be sent to the monitoring service 18 via hardwire 20 or by a communications network 22. The communications network 22 may be a global communications network such as the Internet, a telephone network, a wireless network, satellite communication system and the like.

The monitoring service 18 then relays the alarm signal to a dispatch system 24 over the communications network 22. The dispatch system 24 may be a computer or it may be a human interface such as an operator assisted switchboard. The alarm signal may contain information regarding the characteristics of the environmental event such as time of the event, severity of the event, type of indicator 16 and the like. The dispatch system 24 then accesses a database 26 that contains information regarding one or more pre-approved vendors.

The vendors are pre-approved according to their qualifications and/or certifications to respond to a particular environmental event. For example, a pre-approved vendor for a water leak may be a licensed plumber whereas a pre-approved vendor for a chemical spill may be a firm licensed to handle hazardous materials. The database 26 uses information about the environmental event from the monitoring service 18 and/or the alarm signal to select a pre-approved vendor 28.

The dispatch system 24 then contacts the selected vendor 28 to request service for the environmental event. Information regarding the environmental event is relayed to the selected vendor 28 so that service may be expedited. The selected vendor 28 then dispatches personnel 30 to the client location 12. Personnel 30 may correct the environmental event and/or repair damage to the customer location 12 that may have resulted from the environmental event. The event detector 14 may be monitored continuously to ensure that the environmental event is corrected. After any corrections and/or repairs are completed, the selected vendor 28 confirms correction and/or repair to the dispatch system.

In one embodiment of the invention, the monitoring service 18, the dispatch system 24 and the database 26 may all be incorporated into an environmental detection and response system 32. The detection and response system 32 may be a single location that efficiently houses monitoring and dispatch functions. Alternatively, the detection and response system 32 may be a computer that monitors event detectors 14, detects alarm signals resulting from environmental events, selects the vendor 28 from the database, and confirms that the environmental events were corrected.

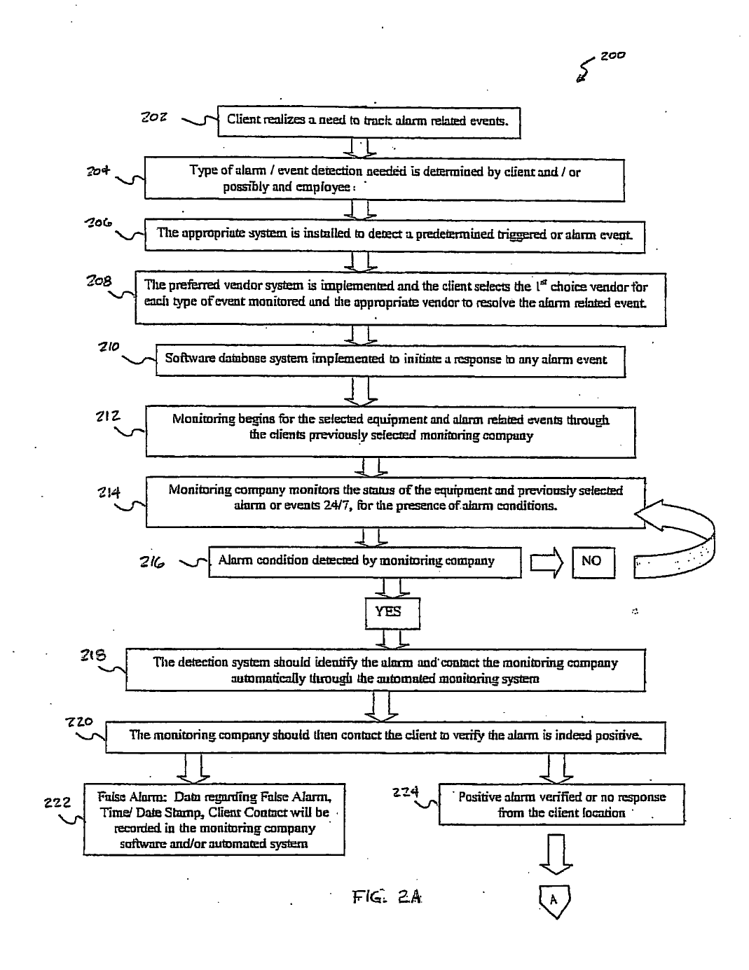

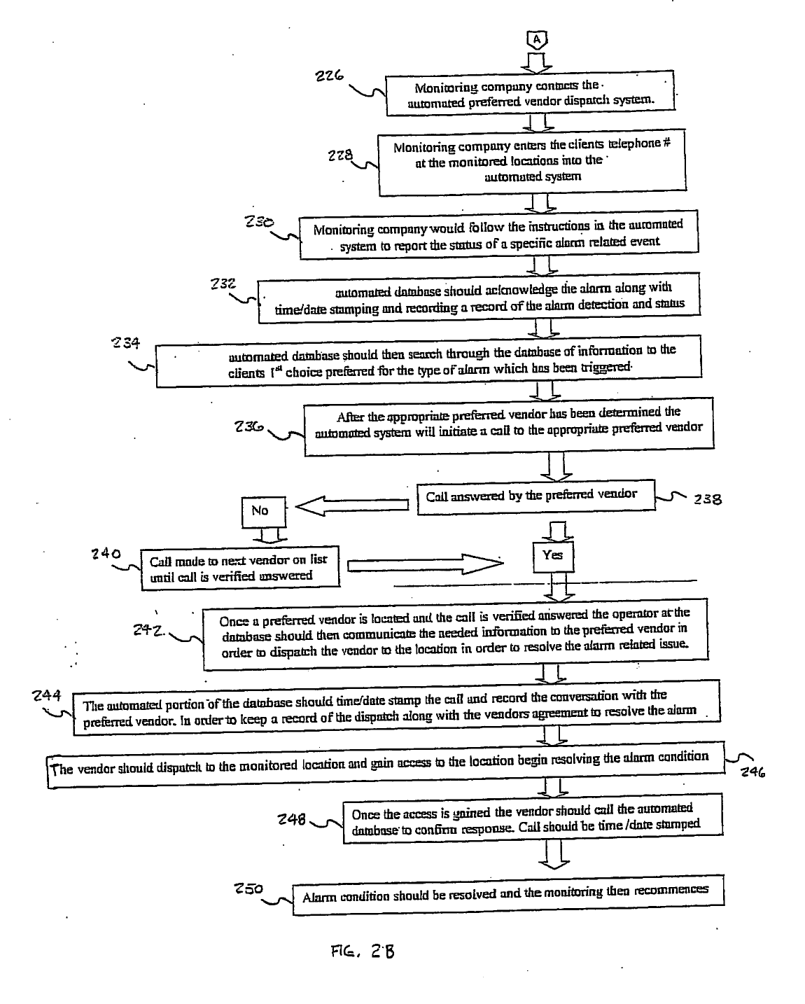

Referring now to FIGS. 2A and 2B, an environmental monitoring system 200 is initiated in block 202 when a client realizes a need to protect a location from an environmental event. In block 204, the client and an environmental monitoring service provider determine which types of environmental events to monitor. For example, if the client is a homeowner, the client may want to monitor for water leaks, elevated relative humidity, carbon monoxide and the like. If the client stores perishable goods, the client may want to monitor temperature and humidity within a storage facility. In block 206, appropriate event detectors are installed at the client's location to monitor the desired environmental conditions. The client then selects and prioritizes pre-approved vendors in block 208. The pre-approved vendors are qualified to correct or repair damage caused if an environmental event occurs at the client's location.

In block 210, information regarding the pre-approved vendors is entered into a database. The database is then configured to select a pre-approved vendor in response to an environmental event. As depicted in block 212, the event detectors are monitored by the monitoring service. This monitoring may be in conjunction with monitoring ordinary alarm system functions such as fire or burglary. The monitoring service monitors the status of the event detectors continuously in block 214. If an alarm condition is detected by the event detectors in block 216, the monitoring service is alerted and may identify the alarm condition in block 218. If no alarm condition is detected, the monitoring service continues to monitor for alarm conditions in block 214.

If an alarm is detected in block 218, the monitoring service attempts to contact the client in block 220 to verify the alarm. If the alarm is false, the false alarm is documented in block 222. The time and date of the false alarm is noted and the client contact is recorded. If a positive alarm is verified or contact with the client is not made in block 224, the monitoring service accesses an automated system for selecting a pre-approved vendor from the database in block 226. In block 228, the monitoring service enters client information into the automated system. The monitoring service follows instruction by the automated system to report the alarm in block 230.

The alarm is acknowledged by the automated system in block 232 and then the automated system initiates a pre-approved vendor search in the database in block 234. The automated system may select the pre-approved vendor according to information associated with the alarm such as type of environmental event, client, location, time of the alarm, and the like. Additionally, the automated system may select a list of one or more pre-approved vendors and prioritize the selected vendors according to client preference or other criteria such as distance from the client location, service ratings, average response time and the like.

After a pre-approved vendor is selected from the database, the automated system initiates communication with the approved vendor in block 236. The communication may be a telephone call, an e-mail, a video conference or other form of communication. The communication may be over a telephone network, a wireless network, a global communications network such as the Internet, a satellite communication system and the like. Block 238 determines if the communication is answered by the selected vendor. If the communication is not answered, the automated system initiates a communication to the next selected pre-approved vendor in block 240.

After a selected pre-approved vendor is contacted, in block 242 the monitoring service dispatches the vendor to the specified location to correct the environmental condition that caused the alarm. The automated system records the communication between the monitoring service and the selected vendor in block 244. A time and date stamp corresponding to the communication is also placed in the record of the communication.

The selected vendor then travels to the client location, accesses the location and begins correcting the environmental event or alarm condition in block 246. The selected vendor communicates with the automated system in block 248 and verifies the successful dispatch. In block 250 the automated system monitors the event detector to confirm that the environmental condition is addressed, corrected or abated. The monitoring service continues to monitor the event detector.

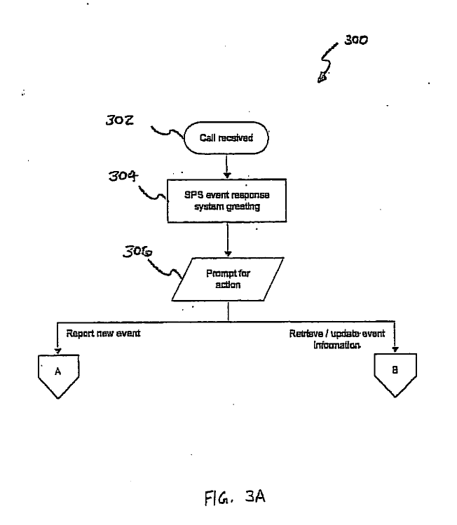

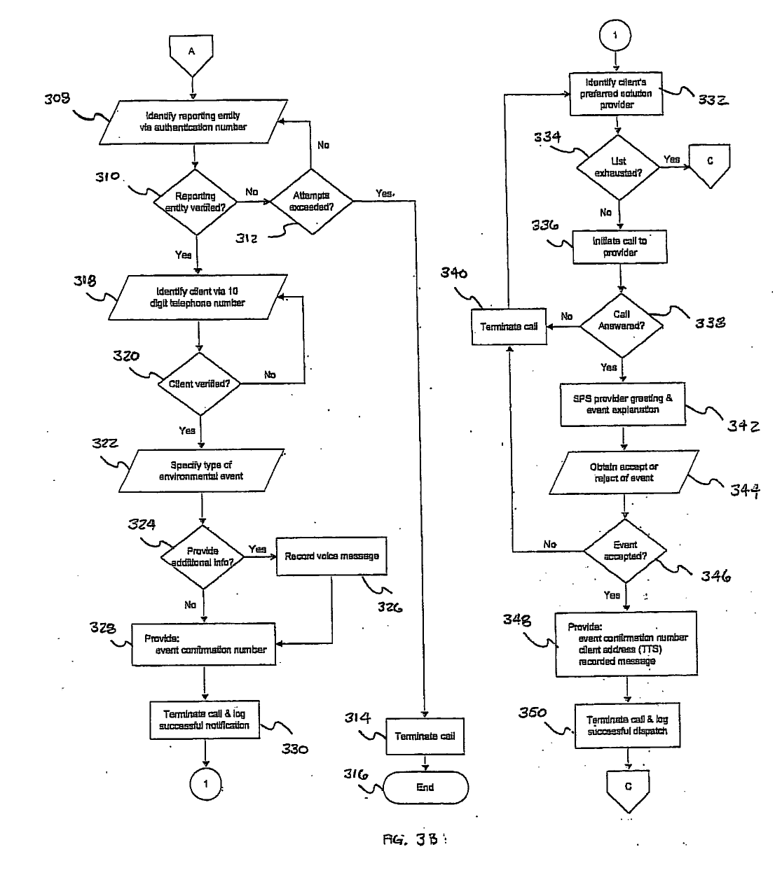

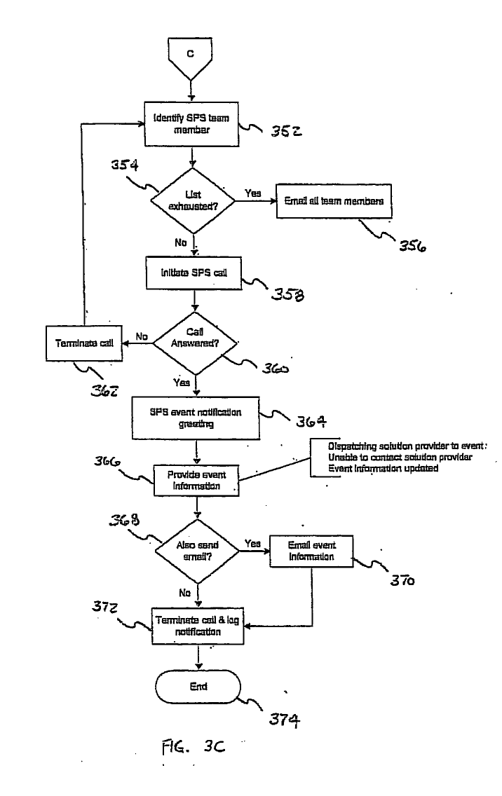

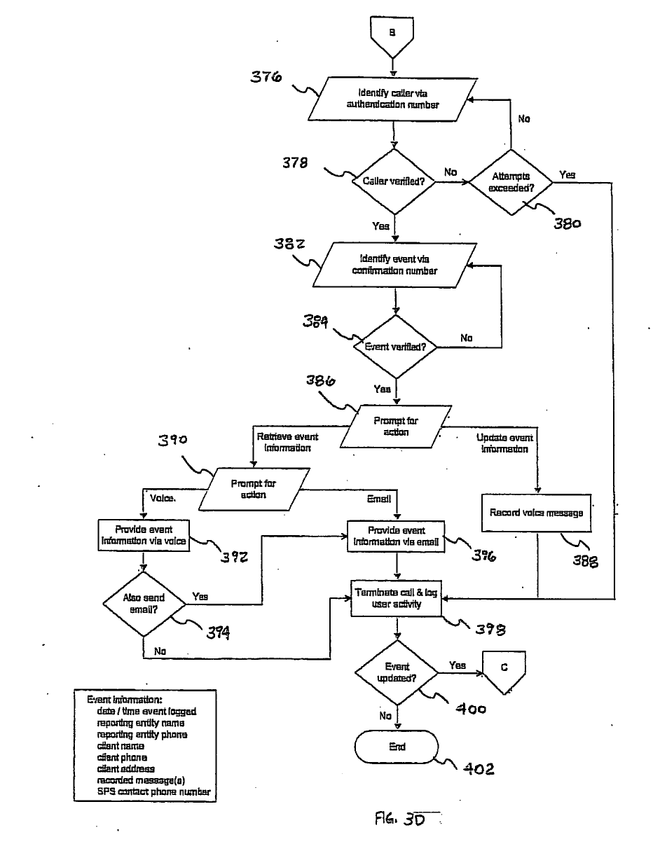

Referring now to FIGS. 3A-3D, an automated response system 300 according to one embodiment of the invention is depicted. In FIG. 3A, the automated response system 300 receives a communication from a user in block 302. The user is typically the monitoring service as described above. The automated response system 300 may deliver a greeting to the user in block 304 and then in block 306 the user is prompted to either report a new environmental event or retrieve/update information regarding an existing event. The retrieve/update information for an existing event is depicted in FIG. 3D and will be described in detail below.

If the user chooses to report a new event, the automated response system 300 identifies the reporting entity using an authentication number in block 308, which is depicted in FIG. 3B. If the reporting entity is not verified in block 310, the automated response system 300 evaluates whether a predetermined number of authentication attempts has been exceeded in block 312. If the number of attempts has been exceeded, the call is terminated in block 314 and the process ends in block 316. If the number of attempts to verify the reporting entity has not been exceeded, the automated response system 300 attempts to verify the reporting entity again in block 308. If the reporting entity is verified in block 310, the client is identified by telephone number in block 318. If the client is verified in block 320, the user is prompted to specify the type of environmental event to be reported in block 322. The user may provide additional information about the event in block 324. If the user decides to provide additional information, a voice message may be recorded in block 326 and an event confirmation number is provided in block 328. If the user does not provide additional information, the automated response system simply provides the event confirmation number to the user in block 328. The call is terminated and a successful notification is logged in block 330.

The automated response system then identifies the client's preferred solution provider in block 332. If block 334 determines the client's list of preferred solution providers is exhausted, the automated response system 300 executes a process of contacting a system provider. One embodiment of this process is depicted in FIG. 3C and will be described in greater detail with reference to FIG. 3C. If the client's list of preferred solution providers is not exhausted, a call to a provider is initiated in block 336.

If block 338 determines the call is not answered, block 340 terminates the call and block 332 identifies the next preferred solution provider on the client's list. When the automated response system 300 determines that a provider answers the call in block 338, an automated greeting and event explanation is provided in block 342. The automated response system 300 then obtains an acceptance or rejection of the event in block 344. If the provider rejects that event, as determined by block 346, block 340 terminates the call and another provider is selected. If block 346 determines that the provider accepts the event, block 348 provides an event confirmation number and the client's address. The call is then terminated and a successful dispatch is logged in block 350.

Turning now to FIG. 3C, the automated response system 300 provides an event notification to a person associated with the provider of the automated response system 300. This person may be an employee responsible for quality control or someone interested in customer satisfaction and service. Block 352 identifies the person associated with the provider of the automated response system 300. Block 354 determines if the list of persons is exhausted. If the list has been exhausted, an alternate communication such as an e-mail, electronic page, text message or other electronic communication, is sent to all persons associated with the provider of the automated response system 300.

If block 354 determines that the list has not been exhausted, the automated response system initiates a telephone call to the person identified in block 352. Block 360 determines if the call is answered. If the call is not answered, block 362 terminates the call and the next person on the list is identified. If block 360 determines that the call has been answered, block 364 provides an event notification greeting to the person. Information regarding the event is then provided in block 366. This provided information may include the time that the event was reported, the time that a service provider was contacted, whether the service provider has been dispatched, and other information related to the event.

In block 368 the contacted person elects whether to have the automated response system 330 send an alternate form of communication, such as an e-mail or a text message, for example. If the contacted person elects to have the alternate communication sent, the automated response system 300 sends the communication in block 370. The call is then terminated and logged in block 372. Otherwise, the call is simply terminated and logged in block 372. The process then ends in block 374.

Turning now to FIG. 3D, a process for retrieving or updating event information is depicted. The event information may include, for example, the date and time that an event is logged, the name of the party reporting the event, the phone number of the reporting party, the client name, the client phone number, the client address, a recorded message and/or the contact number of the provider of the automated response service. The caller is identified by an authentication number in block 376. If the caller cannot be verified in block 378, block 380 determines if the number of attempts to verify has been exceeded. If the attempts have been exceeded, block 398 terminates the call and logs user activity. If the attempts have not been exceeded, block 376 attempts to identify the caller again until the caller is verified in block 378 or block 380 determines the number of attempts have been exceeded.

Block 382 then attempts to identify the event using the confirmation number. Block 384 verifies the event and then block 386 prompts the user to retrieve event information or update event information. If the user chooses to update event information in block 386, block 388 records a voice message and block 398 terminates the call and logs the user activity.

Alternately, if the user elects to retrieve event information in block 386, block 390 allows the user to receive the event information by a voice message or in an electronic text format. If the user elects a voice message, block 392 provides the event information to the user by voice message. Block 394 allows the user to elect to also receive the event information in electronic text format.

If the user elects to receive event information by electronic text in block 390 or 394, the event information is sent by e-mail, text message, instant message or other form of text communication. The call is then terminated and the user activity is logged in block 398. Block 400 determines if the event has been updated. If the event has been updated, the automated response system 300 starts subroutine C, which is described with reference to FIG. 3C. If the event has not been updated, the process ends in block 402.

Although this invention has been described with reference to an illustrative embodiment, this description is not intended to limit the scope of the invention. Various modifications and combinations of the illustrative embodiments as well as other embodiments of the invention will be apparent to persons skilled in the art upon reference to the description. It is therefore intended that the appended claims accomplish any such modifications or embodiments.

1. A method of responding to an environmental event, comprising:
monitoring one or more event detectors within an environment;
triggering an alarm when the one or more event detectors indicate an environmental event has occurred;
automatically notifying a monitoring service of the environmental event;
verifying the existence of the environmental event;
requesting service from a pre-approved vendor, the pre-approved vendor being qualified to address the environmental event; and
verifying that the pre-approved vendor has addressed the environmental event.

2. The method of claim 1, wherein monitoring one or more event detectors is continuous.

3. The method of claim 1, wherein the monitoring service is a fire alarm monitoring service.

4. The method of claim 1, wherein the monitoring service is a burglar alarm service.

5. The method of claim 1, further comprising the step of receiving data from the monitoring service at a central location.

6. The method of claim 5, wherein the step of receiving data is receiving data over a communications network.

7. The method of claim 1, wherein the pre-approved vendor is automatically selected from a database containing one or more pre-selected vendors.

8. The method of claim 1, further comprising:
requesting that the pre-approved vendor repair damage caused by the environmental event; and
verifying that the pre-approved vendor has repaired the damage.

9. A system for responding to an environmental event, comprising:
an event detector to detect the environmental event;
a monitoring system connected to the event detector, the monitoring system configured to generate an alarm when the environmental event is detected;
a dispatch system to receive the alarm from the monitoring system; and
a database accessible by the dispatch system, the database containing pre-approved vendors, the pre-approved vendors qualified to address the environmental event.

10. The system of claim 9, wherein the dispatch system initiates selection of a pre-approved vendor by the database in response to the alarm.

11. The system of claim 10, wherein the alarm has data related to the environmental event and the database selects a pre-approved vendor according to the data.

12. The system of claim 9, wherein the event detector is continuously monitored by the monitoring system.

13. The system of claim 9, wherein the monitoring system is a fire alarm monitoring system.

14. The apparatus of claim 9, wherein the monitoring system is a burglar alarm system.

15. The system of claim 9, wherein the dispatch system receives the alarm over a communications network.

16. The system of claim 9, wherein the dispatch system automatically selects a pre-approved vendor from the database.

17. A method of responding to an environmental event, comprising:
receiving a notification of the environmental event from an authorized source;
identifying the environmental event;
selecting a pre-approved vendor, the pre-approved vendor being qualified to address the environmental event;
requesting service from the pre-approved vendor; and
verifying that the pre-approved vendor has addressed the environmental event.

18. The method of claim 17, further comprising the step verifying the identity of the authorized source.

19. The method of claim 17, wherein the step of receiving a notification is receiving a notification through a global communications network.

20. The method of claim 17, wherein the step of selecting the pre-approved vendor is automatically selecting the pre-approved vendor from a database containing one or more pre-approved vendors.
